(19) United States
(12) Patent Application Publication
(10) Pub. No.: US 2013/0043101 A1
(43) Pub. Date: Feb. 21, 2013

(54) IMPACT ABSORBER

(71) Applicants: Yoshiyuki Takahashi, Yokohama-shi (JP); Shin Tada, Yokohama-shi (JP)

(72) Inventors: Yoshiyuki Takahashi, Yokohama-shi (JP); Shin Tada, Yokohama-shi (JP)

(73) Assignee: BRIDGESTONE CORPORATION, Chuo-ku, Tokyo (JP)

(21) Appl. No.: 13/643,778

(22) PCT Filed: Apr. 27, 2011
(86) PCT No.: PCT/JP2011/060280

§ 371 Date: Oct. 26, 2012

(30) Foreign Application Priority Data
Apr. 30, 2010 (JP) 2010-105354
Apr. 30, 2010 (JP) 2010-105360

(51) Int. Cl. F16F 7/12

(52) U.S. Cl. 188/377

(57) ABSTRACT

A main body portion (12) of an impact absorber (10) is a three-dimensional structure formed of stiff polyurethane foam. A ratio (W2/W1) of a width W2 of a slot (30) formed in an impact surface (12A) of the main body portion (12) to a width W1 of the impact surface (12A) of the main body portion (12) is in a range from ⅙ to ½. In consequence, when a knee area M1 of an occupant M impacts against the impact surface (12A) of the main body portion (12) of the impact absorber (10), a concentration of loading on the impact surface (12A) in an initial impact period is suppressed because the slot (30) is formed in the impact surface (12A), which is most liable to bear the load in the initial impact period, and the load is dispersed. Thus, a large breakage or significant scattering of the main body portion (12) of the impact absorber (10) in the initial impact period may be suppressed, and amounts of impact absorption energy in a middle impact period and a later impact period may be assured.

### TECHNICAL FIELD

The present invention relates to an impact absorber, and particularly relates to an impact absorber for absorbing impact energy that is applied to an occupant in a vehicle cabin during an automobile crash or the like, and reducing injury values.

### BACKGROUND ART

Heretofore, in order to absorb an impact and protect an occupant when the occupant impacts against the interior trimmings of a vehicle cabin or the like, such as when an automobile crashes or the like, an impact absorber has been disposed between the interior trimmings of the vehicle cabin and the vehicle body.

This impact absorber may be a body made of stiff polyurethane foam (for example, see the below-mentioned Patent Document 1). In this impact absorber, the stiff polyurethane foam is integrated with a supporter layer. Even if the stiff polyurethane foam is broken, the stiff polyurethane foam is linked together by the supporter layer and disintegration is suppressed. As a result, the stiff polyurethane foam does not greatly scatter in the initial period of an impact but stays in a predetermined location, and energy absorption characteristics are exhibited in accordance with design.

### RELATED ART REFERENCES

### Patent References

Patent Document 1: Japanese Patent Application Laid-Open (JP-A) No. 2007-22146

### SUMMARY OF INVENTION

### Technical Problem

The present invention provides an impact absorber that may suppress an increase in material costs and an increase in a number of fabrication steps, and that may suppress significant scattering in an initial period of an impact and exhibit excellent energy absorption characteristics in accordance with design.

### Solution to Problem

A first aspect of the present invention includes: a main body portion structured as a three-dimensional body formed of stiff polyurethane foam; and a slot formed in an impact surface of the main body portion, which impact surface receives an impact, wherein a ratio (W2/W1) of a width W2 of the slot to a width W1 of the impact surface is in a range from ⅙ to ½.

In the aspect described above, the slot is formed in the impact surface, which receives an impact, of the main body portion that is formed as a three-dimensional structure of stiff polyurethane foam. The ratio of the width W2 of the slot to the width W1 of the impact surface (W2/W1 ) is in the range from ⅙ to ½. As a consequence, when an impacting body impacts against the impact surface of the main body portion of the impact absorber, a concentration of loading on the impact surface in the initial period of the impact is suppressed by the slot formed in the impact surface, which is most liable to bear the load in the initial period of the impact, and the load is dispersed. Thus, a large breakage or significant scattering of the main body portion of the impact absorber in the initial impact period is suppressed, and amounts of impact absorption energy in a middle impact period and a later impact period may be assured.

W2/W1 being less than ⅙ would be close to a condition with no slot. Thus, it is preferable if W2/W1 is at least ⅙. If W2/W1 exceeded ½, the impact might not be dispersed in the impact initial period, and it might be difficult to reliably suppress large breakages of the main body portion of the impact absorber.

As a result, because W2/W1 is in the range from ⅙ to ½, the stiff polyurethane foam around the slot absorbs impact energy in the initial impact period. Thereafter, the main body portion of the impact absorber exhibits an impact absorption function. Thus, a large breakage or scattering of the main body portion of the impact absorber in the initial impact period is suppressed, and excellent energy absorption characteristics in accordance with design may be consistently exhibited. Furthermore, because of the structure in which the slot is formed in the impact surface of the main body portion of the impact absorber, an increase in material costs, an increase in a number of fabrication steps and the like may be suppressed.

In a second aspect of the present invention, in the first aspect, the impact surface has an elongated shape, and the slot is formed along the length direction of the impact surface.

In the aspect described above, because the impact surface has a long, narrow shape and the slot is formed along the length direction of the impact surface, excellent energy absorption characteristics may be exhibited in accordance with design, along the length direction of the impact surface.

In a third aspect of the present invention, in the first aspect or the second aspect, the slot is formed at a central portion of the impact surface.

In the aspect described above, because the slot is formed at the central portion of the impact surface, which is most liable to bear the load in the initial impact period, loading at the central portion of the impact surface, which is most likely to fracture in the initial impact period, may be reduced by the slot.

In a fourth aspect of the present invention, in any one of the first to third aspects, the impact surface of the main body portion is smaller than a base surface at the opposite side of the main body portion from the side thereof at which the impact surface is provided, and, viewed from the impact surface side, an outline of the impact surface is within an outline of the base surface.

In the aspect described above, the impact surface of the main body portion is smaller than the base surface at the opposite side of the main body portion from the impact surface and, as viewed from the impact surface side, the outline of the impact surface is at the inside of the outline of the base surface. Therefore, even if an impact load acts from a direction that is inclined with respect to a central axis of the main body portion, the main body portion is reliably likely to deform by axial compression from the impact surface toward the base surface, from the initial impact period to a final impact period. As a result, impact energy may be consistently absorbed from the initial impact period to the final impact period.

In a fifth aspect of the present invention, in any one of the first to fourth aspects, a ratio (H2/H1) of a depth H2 of the slot to a height H1 of the impact surface from the base surface of the main body portion is in a range from 0.05 to 0.15.

In the aspect described above, the ratio (H2/H1) of the depth of the slot H2 to the height H1 of the main body portion from the base surface to the impact surface is in the range from 0.05 to 0.15. Therefore, when an impacting body impacts on the impact surface of the main body portion of the impact absorber, a concentration of loading on the impact surface in the initial impact period is suppressed by the slot formed in the impact surface, which is most liable to bear the load in the initial impact period, and the load may be more effectively dispersed. Thus, a large breakage or significant scattering of the main body portion of the impact absorber in the initial impact period is suppressed further, and amounts of impact absorption energy in the middle impact period and the later impact period may be reliably assured.

H2/H1 being less than 0.05 would be close to a condition with no slot. Thus, it is preferable if H2/H1 is 0.05 or greater. If H2/H1 exceeded 0.15, the stiff polyurethane foam around the slot might break starting from the slot, with the breakage initiating at the bottom thereof, the surrounding stiff polyurethane foam might not exhibit the impact absorption function, and it may be difficult to reliably suppress large breakages of the main body portion of the impact absorber.

In a sixth aspect of the present invention, in any one of the first to fifth aspects, the main body portion is disposed at a region opposing a knee area of an occupant sitting on a seat, and the slot is formed along an up-and-down direction.

In the aspect described above, the main body portion is disposed at the region opposing the knee area of the occupant sitting on the seat. Therefore, when the knee area impacts against the impact surface of the main body portion of the impact absorber, regardless of the height of the knee area, a concentration of loading on the impact surface in the initial impact period is reliably suppressed by the slot that is formed along the up-and-down direction in the impact surface that is most liable to bear the load in the initial impact period, and the load is dispersed. Thus, a large breakage or significant scattering of the main body portion of the impact absorber in the initial impact period is suppressed, and amounts of impact absorption energy in the middle impact period and the later impact period may be assured. As a result, an excellent energy absorption characteristic in accordance with design may be exhibited. Furthermore, because of the structure in which the slot is formed in the impact surface of the main body portion of the impact absorber, an increase in material costs and an increase in a number of fabrication steps may be suppressed.

### ADVANTAGEOUS EFFECTS OF INVENTION

As described hereabove, the first aspect of the present invention provides excellent effects in that, while an increase in material costs and an increase in the number of fabrication steps may be suppressed, significant scattering in the initial impact period may be suppressed and an excellent energy absorption characteristic in accordance with design may be exhibited.

In addition to the effects recited for the first aspect, the second aspect of the present invention provides an excellent effect in that an excellent energy absorption characteristic may be exhibited in accordance with design along the length direction of the impact surface.

In addition to the effects recited for the first aspect or the second aspect, the third aspect of the present invention provides an excellent effect in that loading at the central portion of the impact surface, which is most liable to bear the load in the initial impact period, may be reduced.

In addition to the effects recited for any one of the first to third aspects, the fourth aspect of the present invention provides an excellent effect in that impact energy may be consistently absorbed from the initial impact period to the final impact period.

In addition to the effects recited for any one of the first to fourth aspects, the fifth aspect of the present invention provides an excellent effect in that an excellent impact energy absorption function may be assured.

In addition to the effects recited for any one of the first to fifth aspects, the sixth aspect of the present invention provides an excellent effect in that significant scattering in the initial impact period may be suppressed and an excellent energy absorption characteristic exhibited consistently with respect to the heights of knee areas, which differ between individuals.

### BRIEF DESCRIPTION OF DRAWINGS

FIG. 1 is a perspective view showing an impact absorber in accordance with a first exemplary embodiment of the present invention.

FIG. 2 is a plan diagram showing the impact absorber in accordance with the first exemplary embodiment of the present invention.

FIG. 3 is a front view showing the impact absorber in accordance with the first exemplary embodiment of the present invention.

FIG. 4 is a sectional diagram taken along section line 4-4 of FIG. 3.

FIG. 5 is a sectional diagram taken along section line 5-5 of FIG. 3.

FIG. 6 is a side sectional view showing a positional relationship between the impact absorber in accordance with the first exemplary embodiment of the present invention and a sitting seat occupant.

FIG. 7 is a plan diagram showing an impact absorber in accordance with a Comparative Example.

FIG. 8 is a plan diagram showing an impact absorber in accordance with another Comparative Example.

FIG. 9 is a plan diagram showing a deformed state of the impact absorber in accordance with the Comparative Example.

FIG. 10 is a plan diagram showing a deformed state of the impact absorber in accordance with the other Comparative Example.

FIG. 11 is a perspective view showing an impact absorber in accordance with a second exemplary embodiment of the present invention.

FIG. 12 is a perspective view showing an impact absorber in accordance with a third exemplary embodiment of the present invention.

FIG. 13 is a perspective view showing an impact absorber in accordance with a fourth exemplary embodiment of the present invention.

FIG. 14 is a perspective view showing an impact absorber in accordance with a fifth exemplary embodiment of the present invention.

FIG. 15 is a perspective view showing an impact absorber in accordance with a sixth exemplary embodiment of the present invention.

FIG. 16 is a perspective view showing an impact absorber in accordance with a seventh exemplary embodiment of the present invention.

FIG. 17 is a perspective view showing an impact absorber in accordance with an eighth exemplary embodiment of the present invention.

FIG. 18 is a perspective view showing an impact absorber in accordance with a ninth exemplary embodiment of the present invention.

FIG. 19 is a perspective view showing an impact absorber in accordance with a tenth exemplary embodiment of the present invention.

FIG. 20 is a plan diagram showing an impact absorber in accordance with an eleventh exemplary embodiment of the present invention.

FIG. 21 is a plan diagram showing an impact absorber in accordance with a twelfth exemplary embodiment of the present invention.

FIG. 22 is a plan diagram showing an impact absorber in accordance with a thirteenth exemplary embodiment of the present invention.

FIG. 23 is a plan diagram showing an impact absorber in accordance with a fourteenth exemplary embodiment of the present invention.

FIG. 24 is a perspective view showing an impact absorber in accordance with a fifteenth exemplary embodiment of the present invention.

FIG. 25 is a front view showing the impact absorber in accordance with the fifteenth exemplary embodiment of the present invention.

FIG. 26 is a perspective view showing an impact absorber in accordance with a sixteenth exemplary embodiment of the present invention.

FIG. 27 is a perspective view showing an impact absorber in accordance with a seventeenth exemplary embodiment of the present invention.

FIG. 28 is a perspective view showing an impact absorber in accordance with an eighteenth exemplary embodiment of the present invention.

FIG. 29 is a perspective view showing an impact absorber in accordance with a nineteenth exemplary embodiment of the present invention.

FIG. 30 is a perspective view showing an impact absorber in accordance with a twentieth exemplary embodiment of the present invention.

FIG. 31 is a perspective view showing an impact absorber in accordance with a twenty-first exemplary embodiment of the present invention.

FIG. 32 is a perspective view showing an impact absorber in accordance with a twenty-second exemplary embodiment of the present invention.

FIG. 33 is a perspective view showing an impact absorber in accordance with a twenty-third exemplary embodiment of the present invention.

FIG. 34 is a perspective view showing an impact absorber in accordance with a twenty-fourth exemplary embodiment of the present invention.

FIG. 35 is a plan diagram showing an impact absorber in accordance with a twenty-fifth exemplary embodiment of the present invention.

FIG. 36 is a plan diagram showing an impact absorber in accordance with a twenty-sixth exemplary embodiment of the present invention.

FIG. 37 is a plan diagram showing an impact absorber in accordance with a twenty-seventh exemplary embodiment of the present invention.

FIG. 38 is a plan diagram showing an impact absorber in accordance with a twenty-eighth exemplary embodiment of the present invention.

FIG. 39 is a perspective view showing an impact absorber in accordance with a twenty-ninth exemplary embodiment of the present invention.

### DESCRIPTION OF EMBODIMENTS

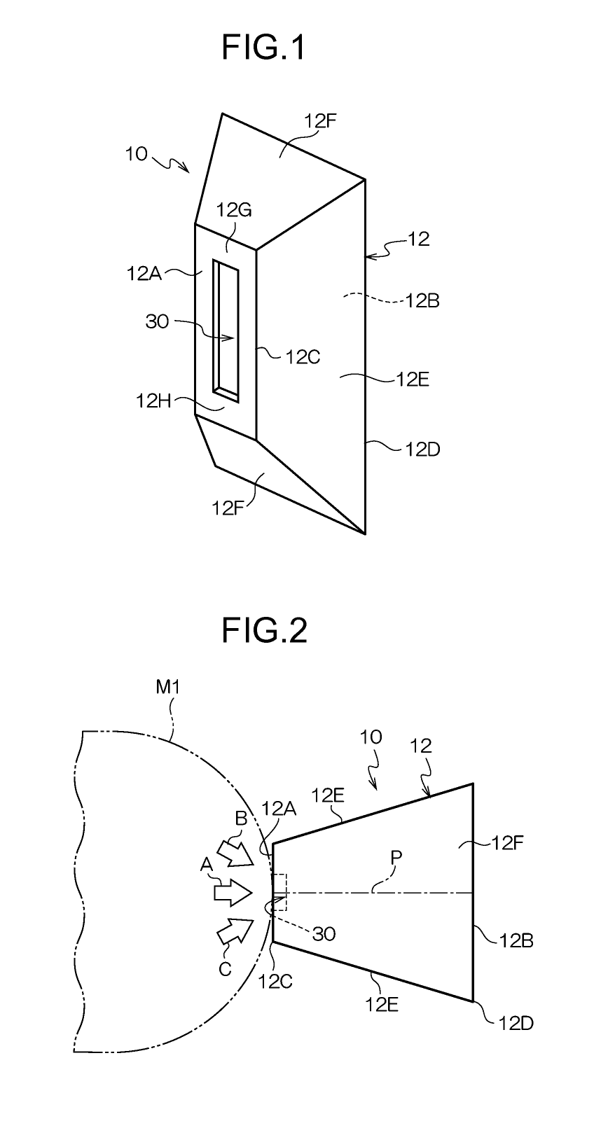

Herebelow, a first exemplary embodiment of the present invention is described on the basis of FIG. 1 to FIG. 6.

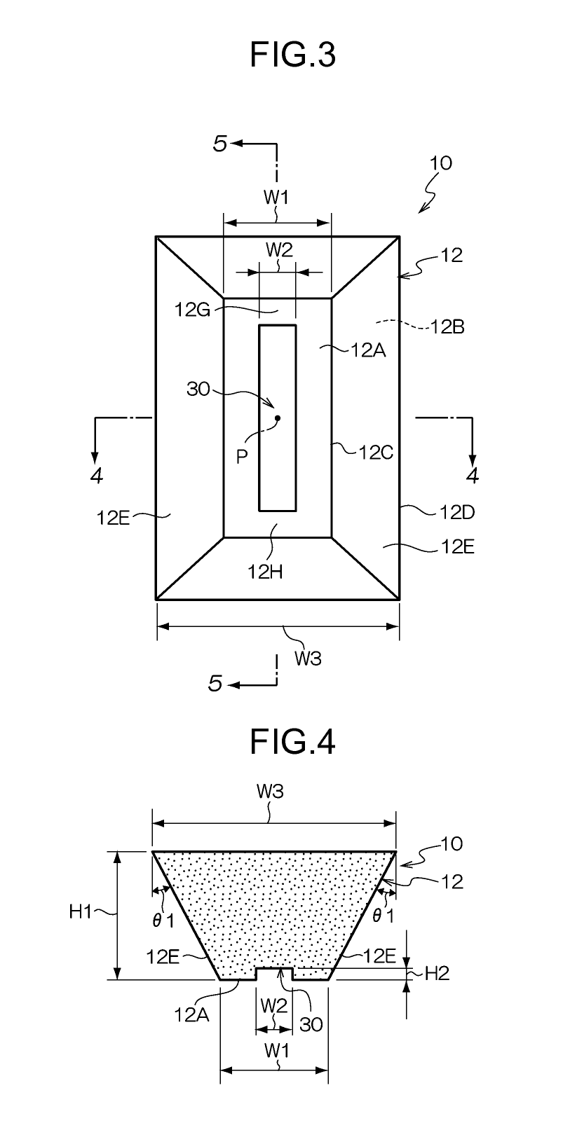

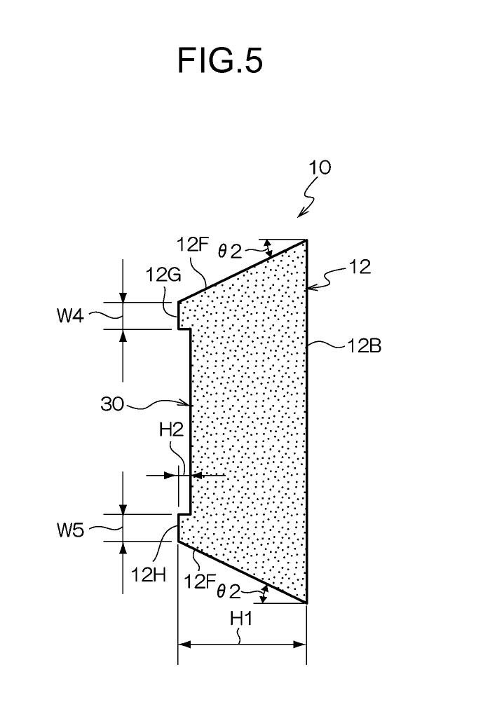

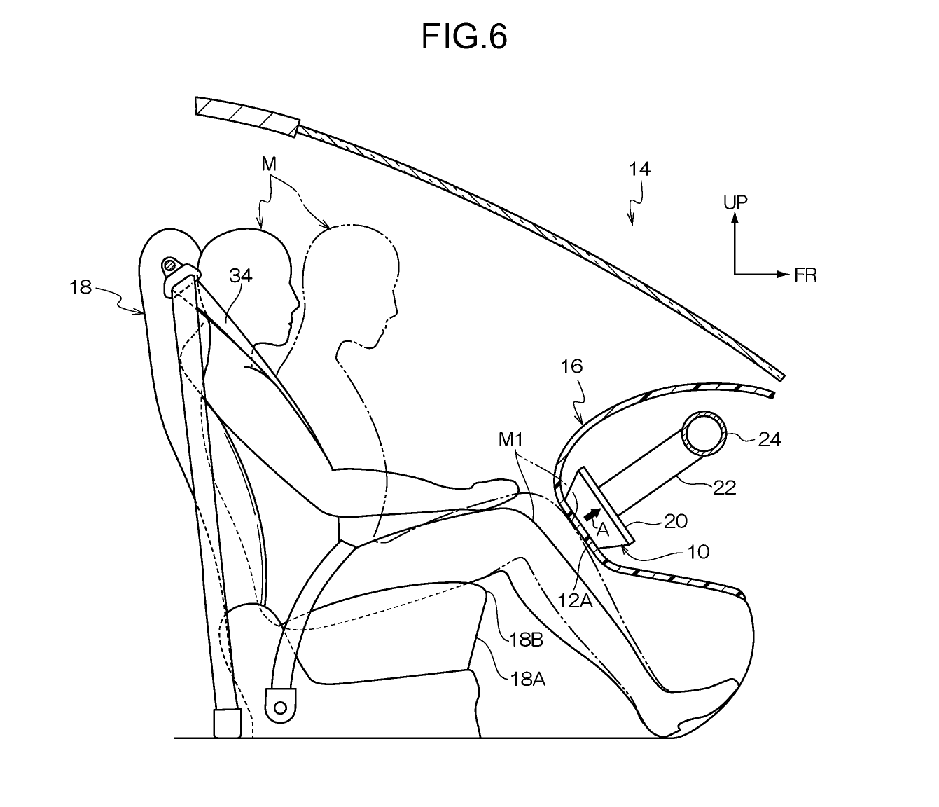

FIG. 1 is a perspective view showing an impact absorber in accordance with a first exemplary embodiment of the present invention, and FIG. 2 is a plan diagram showing the impact absorber in accordance with the first exemplary embodiment of the present invention. FIG. 3 is a front view showing the impact absorber in accordance with the first exemplary embodiment of the present invention, FIG. 4 is a sectional diagram taken along section line 4-4 of FIG. 3, FIG. 5 is a sectional diagram taken along section line 5-5 of FIG. 3, and FIG. 6 is a side sectional view showing a positional relationship between the impact absorber in accordance with the first exemplary embodiment of the present invention and a sitting seat occupant. The arrow UP in FIG. 6 represents an upward direction of the vehicle and the arrow FR represents a forward direction of the vehicle.

As shown in FIG. 6, an impact absorber 10 of the present exemplary embodiment is disposed at the inner side of an instrument panel 16 of an automobile body 14 (the opposite side of the instrument panel 16 from a vehicle cabin interior side thereof).

Describing this more specifically, the instrument panel 16 is disposed forward of a front seat (a seat) 18, which is a seat provided inside a vehicle cabin of the automobile body 14. The impact absorber 10 is disposed at the inner side of the instrument panel 16. A main body portion 12 of the impact absorber 10 is disposed at a region opposing (a kneecap portion of) a knee area M1 of an occupant (a crash test dummy representing an occupant) M seated on the front seat 18.

Thus, when the vehicle body has a frontal collision and the occupant M seated on the front seat 18 moves forward in the vehicle body, as shown by the two-dot chain lines in FIG. 2, the main body portion 12 of the impact absorber 10, sandwiching the instrument panel 16, restrains the knee area M1 of the legs of the occupant M sitting on the front seat 18, from forward and diagonally upward in the vehicle.

The impact absorber 10 is mounted at a mounting plate 20 disposed forward of the front seat 18. The mounting plate 20 is fixed by welding or the like, via a bracket 22, to an instrument panel reinforcer 24, which is a portion of the vehicle body.

The instrument panel reinforcer 24 is formed as a pipe-shaped member with high strength and high stiffness, and is disposed along a vehicle width direction between mounting portions (not shown in the drawings) at the left and right of the vehicle. The bracket 22 is formed of a rod or the like of a metallic material with high strength and high stiffness (for example, steel or the like). The bracket 22 extends in a direction approaching an assumed position of the knee area M1 of the occupant M in the seated condition (in a vehicle side view, a direction substantially the same as a direction from the instrument panel reinforcer 24 toward a front end upper portion 18B of a seat cushion 18A). The mounting plate 20 is formed of a plate with high strength and high stiffness. The mounting plate 20 is joined, at a surface that is perpendicular to an extension direction of the bracket 22, to a vehicle cabin interior side direction end portion of the bracket 22. The impact absorber 10 is mounted by welding or the like to a vehicle cabin interior side face of the mounting plate 20.

As shown in FIG. 1, the main body portion 12 of the impact absorber 10 of the present exemplary embodiment has a trapezoid three-dimensional structure. The main body portion 12 of the impact absorber 10 is constituted of a stiff polyurethane foam specified with a predetermined stiffness.

In the present embodiment, the stiffness of the main body portion 12 is from 2.5 kgf/cm² to 15 kgf/cm² in a static compression test of a core region. For this static compression test, a sample of the material to be used with thickness 50 mm by width 50 mm by length 50 mm is acquired. This sample is compressed, by compression over its whole area, by a distance of 80% of the original thickness at a speed of 10 to 50 mm/min. in the thickness direction (compressed by a distance of 40 mm for the sample with thickness 50 mm), and a load when the sample is compressed to 50% of the original thickness (compressed to 25 mm for the sample with thickness 50 mm is) is measured. A value calculated by dividing the load by the cross-sectional area (for units of kgf/cm², N/cm² or the like) serves as the hardness of the material.

Thus, as shown in FIG. 6, when the main body portion 12 of the impact absorber 10 is pressed by an unusually large force from the vehicle cabin interior side toward the vehicle body front (the direction of arrow A in FIG. 6) by the knee area M1 of an occupant M, the main body portion 12 is deformed by axial compression in the direction of arrow A in association with the movement of the knee area M1.

The main body portion 12 of the impact absorber 10 has a long, narrow shape whose length direction is in the vehicle up-and-down direction. The main body portion 12 is disposed in a range containing positions in front of the assumed positions of the knee areas M1 of numerous occupants M with different statures sitting on the front seat 18. Thus, because the impact absorber 10 of the present invention is used for the knees, a slot that extends in the length direction in accordance with the various heights of the knee areas of the occupants M may suppress large breakage in an initial impact period regardless of the height of the knee area of a seat occupant. Thus, the required impact absorption performance may be reliably provided.

As shown in FIG. 3, an impact surface 12A of the main body portion 12 of the impact absorber 10, which receives the impact from the knee area M1 of an occupant M, has a rectangular shape whose length direction is in the vehicle up-and-down direction. The impact surface 12A of the main body portion 12 of the impact absorber 10 is smaller than a base surface 12B that is at the opposite side of the main body portion 12 from the impact surface 12A. As shown in FIG. 3, viewed from the impact surface 12A side, an outline 12C of the impact surface 12A is within an outline 12D of the base surface 12B.

A single slot 30 is formed at the middle in the width direction (short axis direction) of the impact surface 12A of the main body portion 12 of the impact absorber 10. The slot 30 is formed along the up-and-down direction, which is the length direction of the impact surface 12A. The slot 30 is formed from an upper end vicinity of the impact surface 12A to a lower end vicinity, and forms a recess portion at a central portion of the impact surface 12A.

As shown in FIG. 4, a ratio of a width W2 of the slot 30 to a short axis direction width W1 of the impact surface 12A of the main body portion 12 of the impact absorber 10 (W2/W1) is in a range from ⅙ to ½. In consequence, when the knee area M1 of an occupant M impacts against the impact surface 12A of the main body portion 12 of the impact absorber 10, a concentration of loading on the impact surface 12A, which is most liable to bear the load in an initial impact period, in the initial impact period is suppressed by the slot 30 formed in the impact surface 12A and the load is dispersed. Thus, a large breakage or significant scattering of the main body portion 12 of the impact absorber 10 in the initial impact period is suppressed, and amounts of impact absorption energy in a middle impact period and a later impact period may be assured.

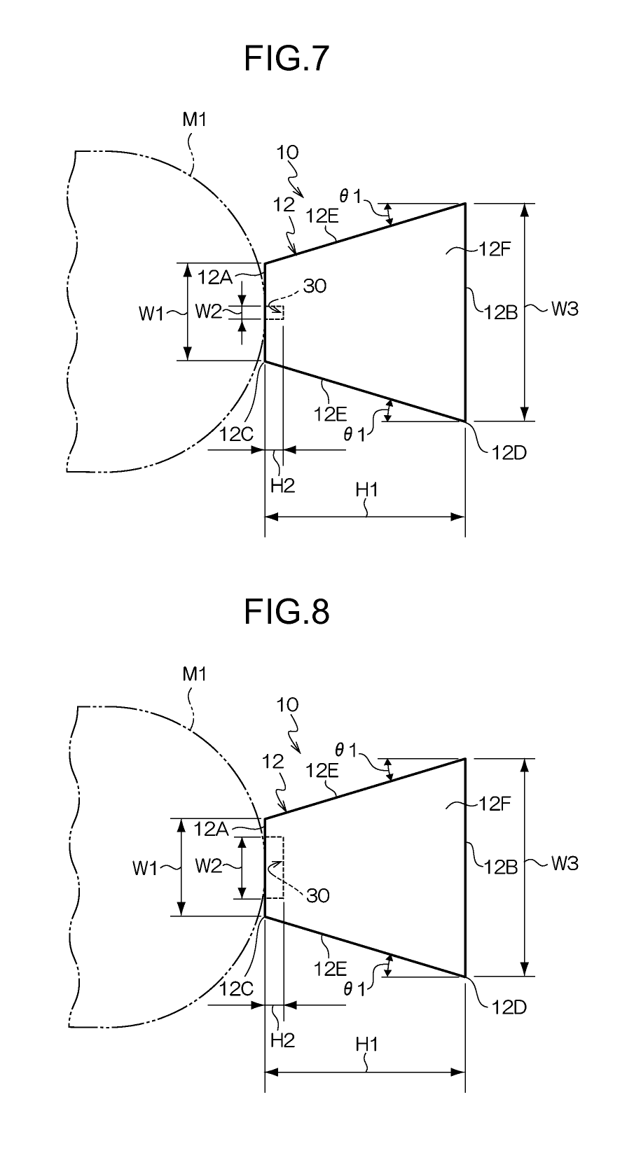

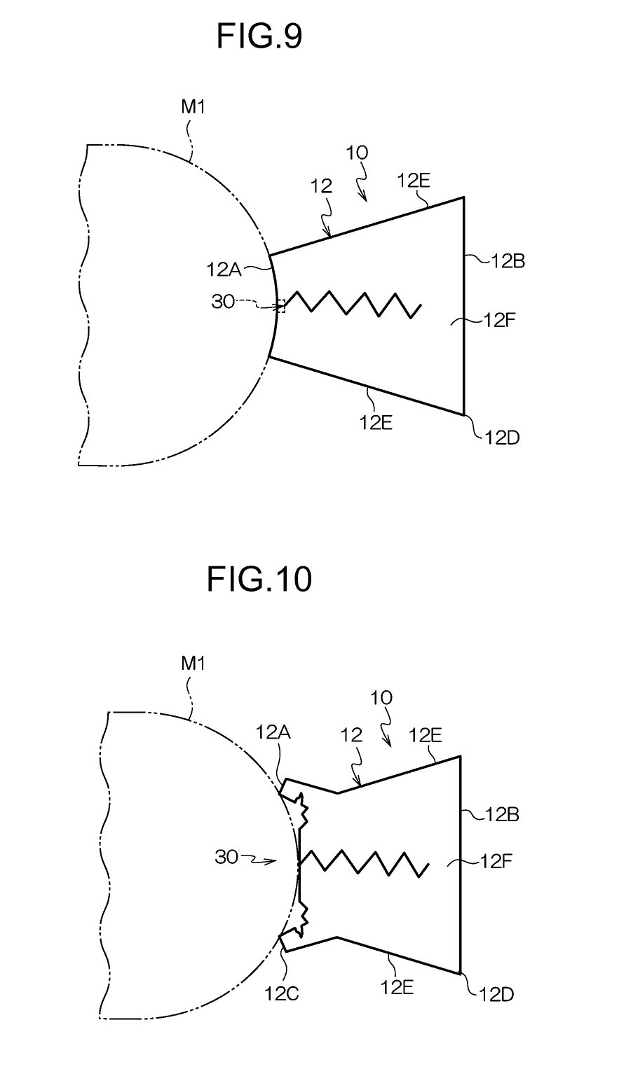

As illustrated in FIG. 7 and FIG. 9, if the ratio (W2/W1) of the width W2 of the slot to the short axis direction width W1 of the impact surface 12A of the main body portion 12 of the impact absorber 10 is less than ⅙, this is close to a state in which the slot 30 is absent, so ⅙ or greater is preferable. As illustrated in FIG. 8 and FIG. 10, if the ratio (W2/W1) of the width W2 of the slot to the short axis direction width W1 of the impact surface 12A of the main body portion 12 of the impact absorber 10 exceeds ½, the load may not be dispersed in the initial impact period and it may be difficult to reliably suppress large breakages of the main body portion 12 of the impact absorber 10.

As shown in FIG. 5, in the present embodiment, a ratio of a depth H2 of the slot 30 to a height H1 from the base surface 12B of the main body portion 12 of the impact absorber 10 to the impact surface 12A (H2/H1) is in a range from 0.05 to 0.15. In consequence, when the knee area M1 of an occupant M impacts against the impact surface 12A of the main body portion 12 of the impact absorber 10, a concentration of loading in the initial impact period on the impact surface 12A that is most liable to bear the load in the initial impact period is suppressed by the slot 30 formed in the impact surface 12A, and the load is effectively dispersed. Thus, a large breakage or significant scattering of the main body portion 12 of the impact absorber 10 in the initial impact period is further suppressed, and amounts of impact absorption energy in the middle impact period and the later impact period may be reliably assured.

If the ratio (H2/H1) of the depth H2 of the slot 30 to the height H1 from the base surface 12B of the main body portion 12 of the impact absorber 10 to the impact surface 12A is less than 0.05, this is close to a state in which the slot 30 is absent, so 0.05 or greater is preferable. If the ratio (H2/H1) of the depth H2 of the slot 30 to the height H1 from the base surface 12B to the impact surface 12A of the main body portion 12 of the impact absorber 10 exceeds 0.15, the stiff polyurethane foam around the slot 30 might break starting from the slot 30, with the breakage initiating at the bottom thereof, the surrounding stiff polyurethane foam might not exhibit the impact absorption function, and it might be difficult to reliably suppress large breakages of the main body portion 12 of the impact absorber 10.

A width W3 in the short axis direction of the base surface 12B of the main body portion 12 of the impact absorber 10 is greater than the short axis direction width W1 of the impact surface 12A (i.e., W1<W3).

A width W4 of a region 12G at which the slot 30 is not formed at the upper end vicinity of the impact surface 12A and a width W5 of a region 12H at which the slot 30 is not formed at the lower end vicinity of the impact surface 12A are equal to the width W2 of the slot 30.

As shown in FIG. 4, an angle of inclination θ1 of left and right wall portions 12E of the main body portion 12 of the impact absorber 10 is preferably at least 3° with regard to demolding during fabrication. As shown in FIG. 5, it is also preferable if an angle of inclination θ2 of upper and lower wall portions 12F of the main body portion 12 of the impact absorber 10 is at least 3°.

As shown in FIG. 6, a seatbelt 34 is provided at the front seat 18 for restraining the occupant M.

Next, operation and effects of the present exemplary embodiment are described.

As shown in FIG. 6, when the automobile body 14 has, for example, a frontal collision, the occupant M sitting on the front seat 18 is moved by inertia during the collision toward the front side of the vehicle, as shown by the two-dot chain lines. At this time, the knee area M1 of the occupant M presses against the impact absorber 10, via the instrument panel 16, and impact energy from the knee area M1 is absorbed by the impact absorber 10.

In the impact absorber 10 of the present embodiment, the main body portion 12 that has a three-dimensional structure formed of stiff polyurethane foam is disposed at the region opposing the knee area M1 of the occupant M sitting on the front seat 18 and, in the main body portion 12, the slot 30 is formed along the up-and-down direction in the impact surface 12A that receives the impact. The ratio (W2/W1) of the width W2 of the slot 30 to the width W1 of the impact surface 12A of the main body portion 12 of the impact absorber 10 is in the range from ⅙ to ½. Therefore, when the knee area M1 of the occupant M impacts against the impact surface 12A of the main body portion 12 of the impact absorber 10, a concentration of loading in the initial impact period on the impact surface 12A that is most liable to bear the load in the initial impact period is suppressed by the slot 30 formed in the impact surface 12A, and the load is dispersed. Thus, a large breakage or significant scattering of the main body portion 12 of the impact absorber 10 in the initial impact period is suppressed, and amounts of impact absorption energy in the middle impact period and the later impact period may be reliably assured. As a result, an excellent energy absorption characteristic in accordance with design may be exhibited.

Further, because of the structure in the present exemplary embodiment in which the slot 30 is formed in the impact surface 12A of the main body portion 12 of the impact absorber 10, an increase in material costs and an increase in a number of fabrication steps may be suppressed.

In the present embodiment, the slot 30 is formed at a central portion in the short axis direction (width direction) of the impact surface 12A, which is most liable to bear the load at the initial impact period stage. Therefore, loading on the width direction central portion of the impact surface 12A, which is most likely to fracture in the initial impact period, may be reduced, and a large breakage or significant scattering of the main body portion 12 may be effectively suppressed.

As shown in FIG. 3, in the present embodiment, the impact surface 12A of the main body portion 12 of the impact absorber 10 is smaller than the base surface 12B and, as viewed from the impact surface side, the outline 12C of the impact surface 12A is within the outline 12D of the base surface 12B. Therefore, even if, for example, an impact load acts from a direction that is angled to up, down, left or right relative to a central axis P of the main body portion 12 of the impact absorber 10, as shown by arrow B or arrow C in FIG. 2, the main body portion 12 may assuredly deform by axial compression from the impact surface 12A toward the base surface 12B, from the initial impact period to a final impact period. As a result, impact energy may be consistently absorbed from the initial impact period to the final impact period.

In the present embodiment, the ratio (H2/H1) of the depth H2 of the slot 30 to the height H1 from the base surface 12B of the main body portion 12 of the impact absorber 10 to the impact surface 12A is in the range from 0.05 to 0.15. Therefore, a concentration of loading on the impact surface 12A in the initial impact period is suppressed, and the load is even more effectively dispersed. Thus, a large breakage or significant scattering of the main body portion 12 of the impact absorber 10 in the initial impact period is further suppressed, and amounts of impact absorption energy in the middle impact period and the later impact period may be reliably assured.

### Experiment 1

In order to verify the effects of the present invention, two Comparative Example impact absorbers (one with no slot 30 and one with H2/H1 at 0.10 and W2/W1 at ⅔) and three Example impact absorbers applying the present invention (with H2/H1 at 0.10 and W2/W1 at ⅙, ⅓ and ½) were prepared and impact absorption tests (relative evaluations) were conducted.
Details of the impact absorption test: A hemispherical impact body made of aluminium with a spheroidal impact surface, with a diameter of 100 mm (radius 50 mm), was impacted against an impact surface of an impact absorber (120 mm by 70 mm by 110 mm high) at 6.7 m/s. The impact energy was calculated from a graph of the deformation stroke of the impact surface of the impact absorber (displacement amounts of the impact body) against the load acting on the impact body. Evaluations were performed with the impact energy of the impact absorber with no slot (Comparative Example 1) being 100%.
Results of the impact absorption test

TABLE 1

| Impact | Comparative | Example | Example | Example | Comparative |
|---|---|---|---|---|---|
| absorber | Example 1 | 1 | 2 | 3 | Example 2 |
| W1/W2 | No slot | 1/6 | 1/3 | 1/2 | 2/3 |
| Result | Reference | B | A | B | C |

A in table 1 indicates that a clear effect was seen, with the impact energy increased by at least 25%.
B in table 1 indicates that an effect could be identified, with the impact energy increased by at least 15%.
C in table 1 indicates that an effect could be identified, with an increase of around 5% in repeated testing.

### Experiment 2

In order to verify the effects of the present invention, one Comparative Example impact absorber as in FIG. 1 (with no slot 30) and four Example impact absorbers applying the present invention (with W2/W1 at ⅓ and H2/H1 at 0.05, 0.1, 0.15 and 0.2) were prepared and impact absorption tests (relative evaluations) were conducted.
Details of the impact absorption test: A hemispherical impact body made of aluminium with a spheroidal impact surface, with a diameter of 100 mm (radius 50 mm), was impacted against an impact surface of an impact absorber (120 mm by 70 mm by 110 mm high) at 6.7 m/s. The impact energy was calculated from a graph of the deformation stroke of the impact surface of the impact absorber (displacement amounts of the impact body) against the load acting on the impact body. Evaluations were performed with the impact energy of the impact absorber with no slot (Comparative Example 1) being 100%.
Results of the impact absorption test

TABLE 2

| Impact | Comparative | Example | Example | Example | Example |
|---|---|---|---|---|---|
| absorber | Example 1 | 1 | 2 | 3 | 4 |
| H1/H2 | No slot | 0.05 | 0.1 | 0.15 | 0.2 |
| Result | Reference | B | A | B | C |

A in table 1 indicates that a clear effect was seen, with the impact energy increased by at least 25%.
B in table 1 indicates that an effect could be identified, with the impact energy increased by at least 15%.
C in table 1 indicates that an effect could be identified, with an increase of around 5% in repeated testing.

Evaluation
   Comparing the impact absorbers of the present embodiment, with a slot in the impact surface of the main body portion, with the impact absorber of Comparative Example 1 with no slot and the impact absorber of Comparative Example 2 that has W2/W1 outside the range from ⅙ to ½, it was identified that large breakages in the initial impact period were suppressed and the energy absorption performance during the action of an impact was improved.

In the above descriptions, a specific embodiment of the present invention is described in detail, but embodiments to which the present invention is applied are not limited thus. It will be clear to those skilled in the art that numerous further embodiments may be realized within the technical scope of the present invention.

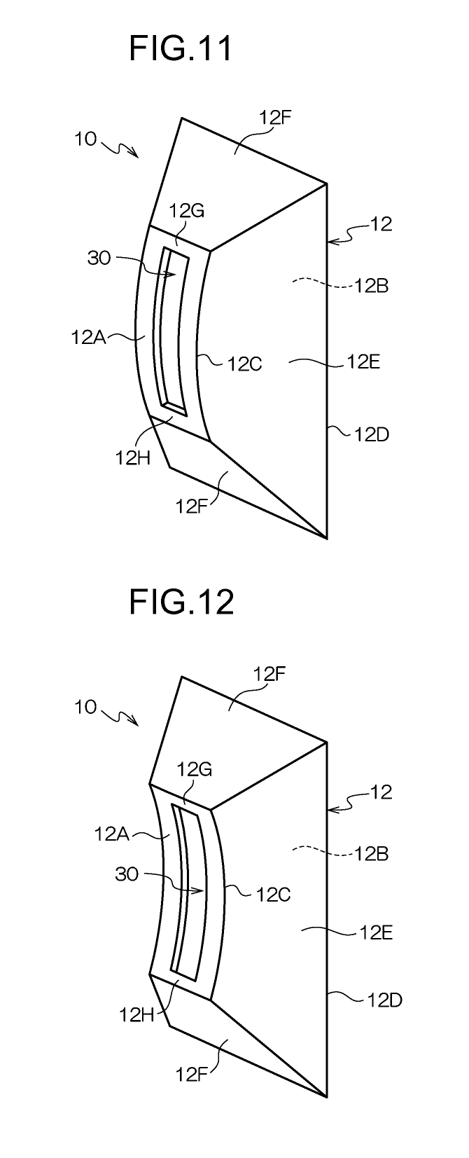

For example, as in a second exemplary embodiment shown in FIG. 11, the impact surface 12A of the main body portion 12 of the impact absorber 10 may be formed in a convex shape that is curved in a circular arc in side view. Further, as in a third exemplary embodiment shown in FIG. 12, the impact surface 12A of the main body portion 12 of the impact absorber 10 may be formed in a concave shape that is curved in a circular arc in side view.

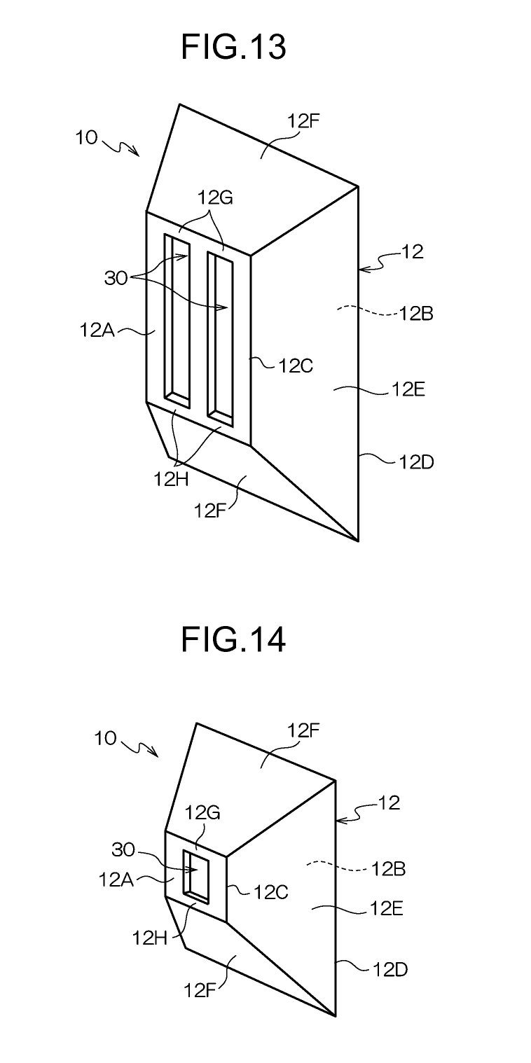

As in a fourth exemplary embodiment shown in FIG. 13, two or more (three or four or the like) of the slot 30 may be formed in the impact surface 12A of the main body portion 12 of the impact absorber 10.

As in a fifth exemplary embodiment shown in FIG. 14, the impact surface 12A and base surface 12B of the main body portion 12 of the impact absorber 10 may have square shapes.

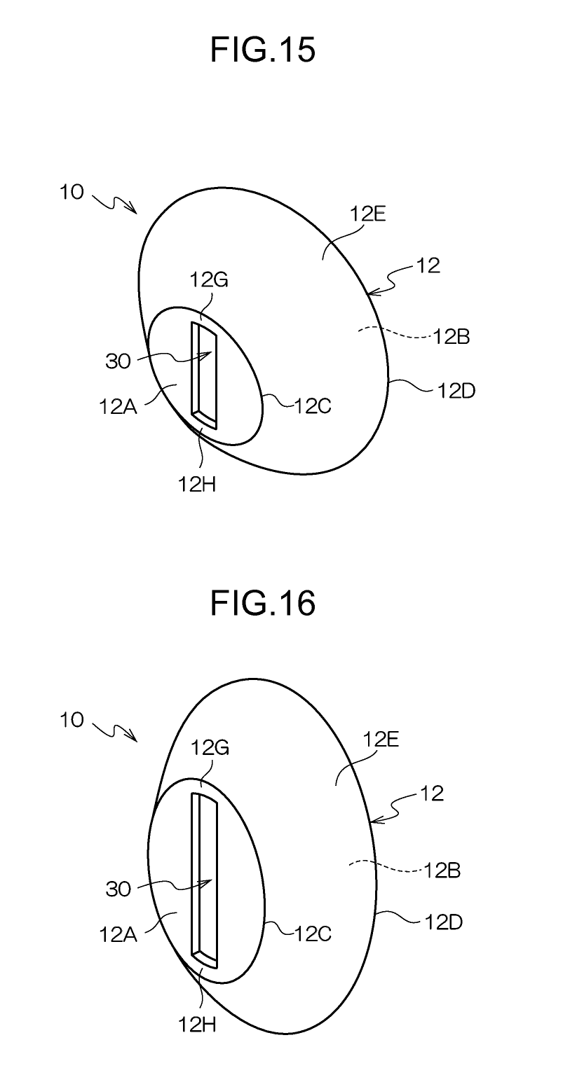

As in a sixth exemplary embodiment shown in FIG. 15, the impact surface 12A and base surface 12B of the main body portion 12 of the impact absorber 10 may have circular shapes.

As in a seventh exemplary embodiment shown in FIG. 16, the impact surface 12A and base surface 12B of the main body portion 12 of the impact absorber 10 may have elliptical shapes.

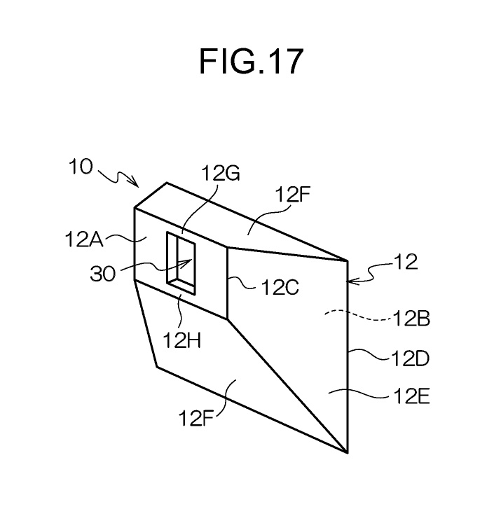

As in an eighth exemplary embodiment shown in FIG. 17, a structure in which the outline 12C of the impact surface 12A is not within the outline 12D of the base surface 12B as viewed from the impact surface 12A side of the main body portion 12 of the impact absorber 10 may be formed; for example, a structure in which the outline 12C of the impact surface 12A is offset upward to the outside of the outline 12D of the base surface 12B. However, structures that are not offset are preferable.

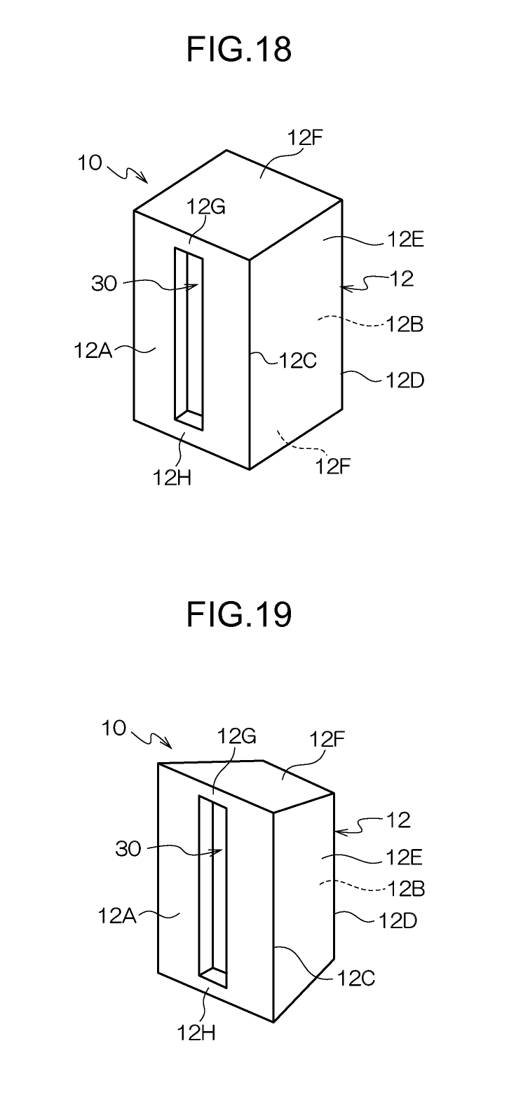

As in a ninth exemplary embodiment shown in FIG. 18, a structure in which the outline 12C of the impact surface 12A matches the outline 12D of the base surface 12B as viewed from the impact surface 12A side of the main body portion 12 of the impact absorber 10 may be formed.

As in a tenth exemplary embodiment shown in FIG. 19, a structure in which the outline 12C of the impact surface 12A is outside the outline 12D of the base surface 12B as viewed from the impact surface 12A side of the main body portion 12 of the impact absorber 10 may be formed.

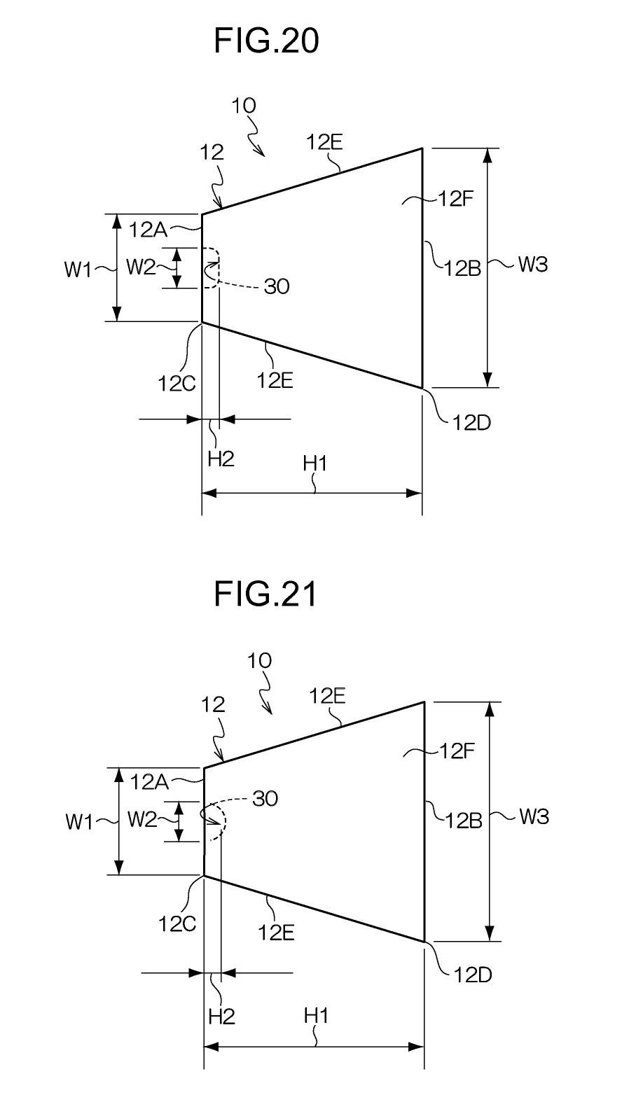

As in an eleventh exemplary embodiment shown in FIG. 20, a cross-sectional shape of the slot 30 may be a “U” shape.

As in a twelfth exemplary embodiment shown in FIG. 21, the cross-sectional shape of the slot 30 may be a semicircular shape.

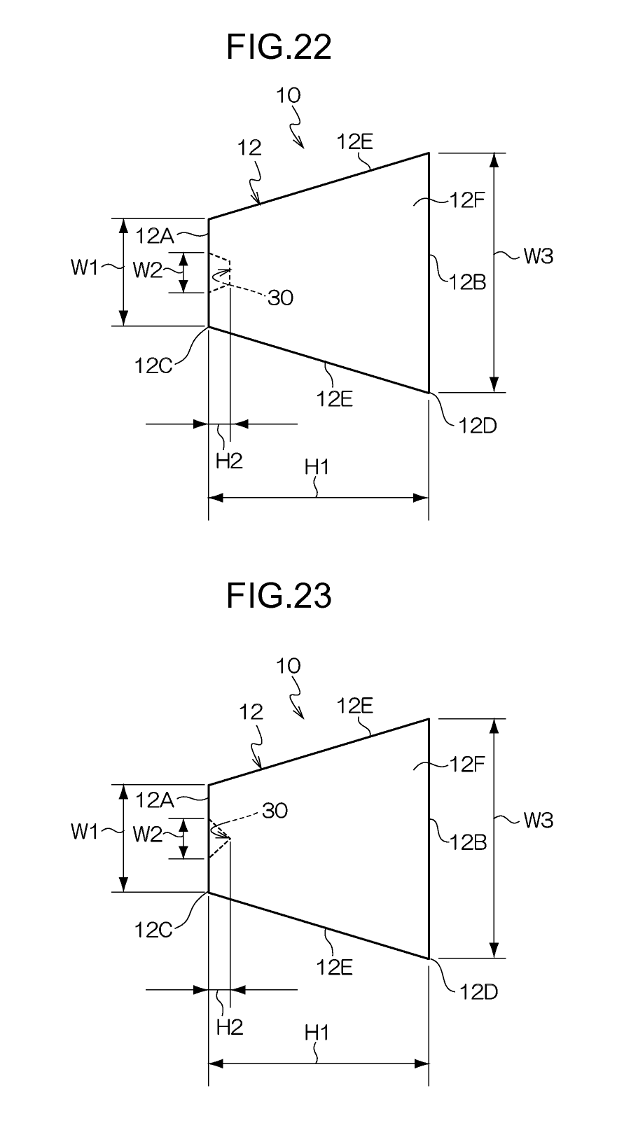

As in a thirteenth exemplary embodiment shown in FIG. 22, the cross-sectional shape of the slot 30 may be a trapezoid shape.

As in a fourteenth exemplary embodiment shown in FIG. 23, the cross-sectional shape of the slot 30 may be a triangular shape.

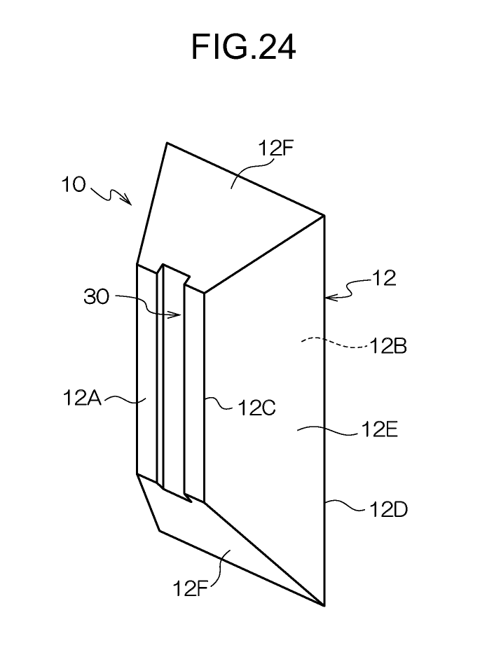

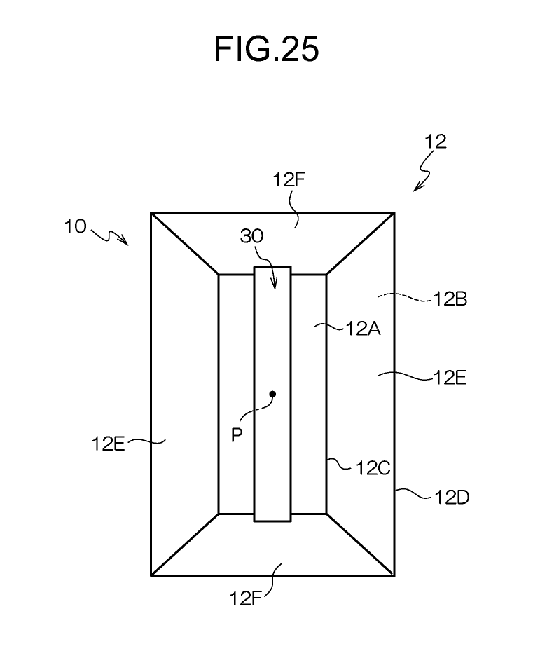

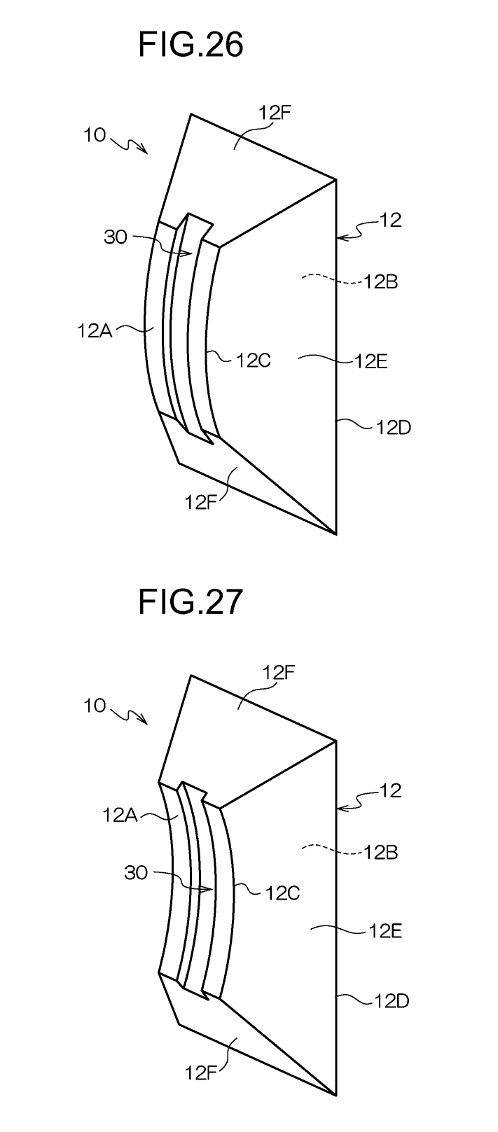

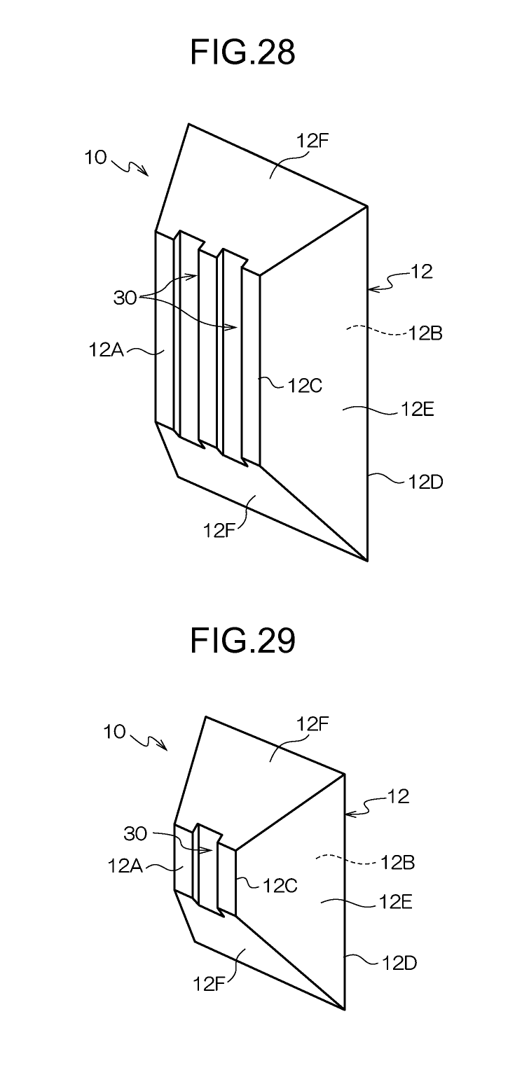

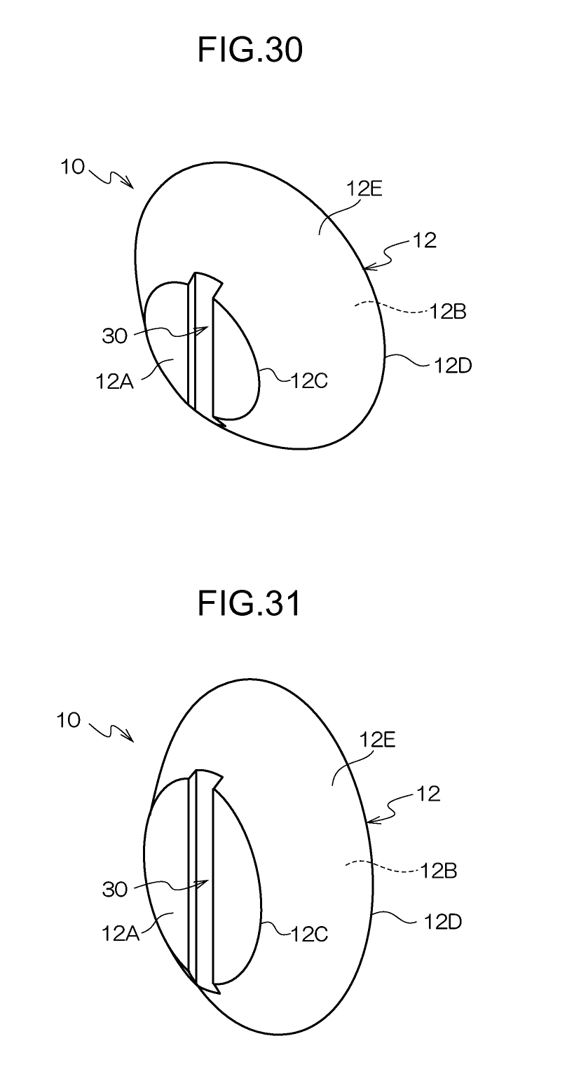

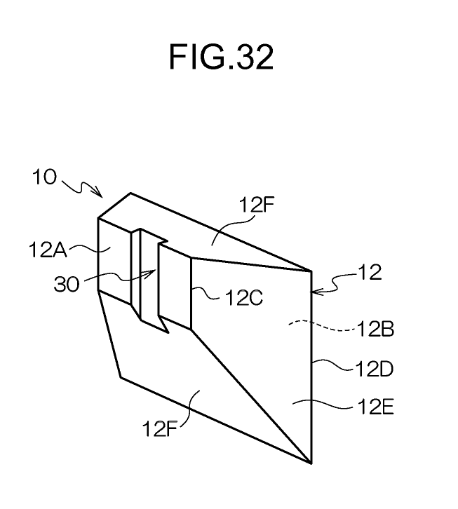

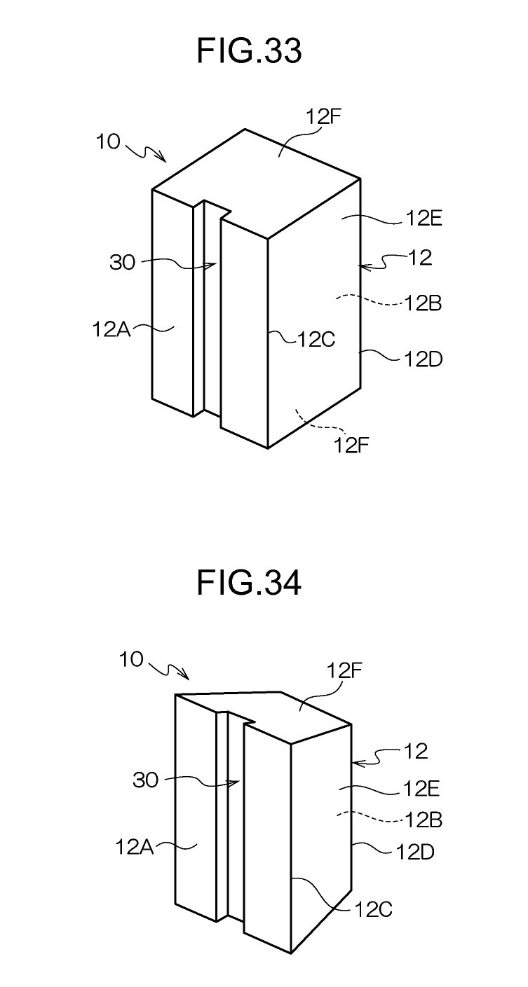

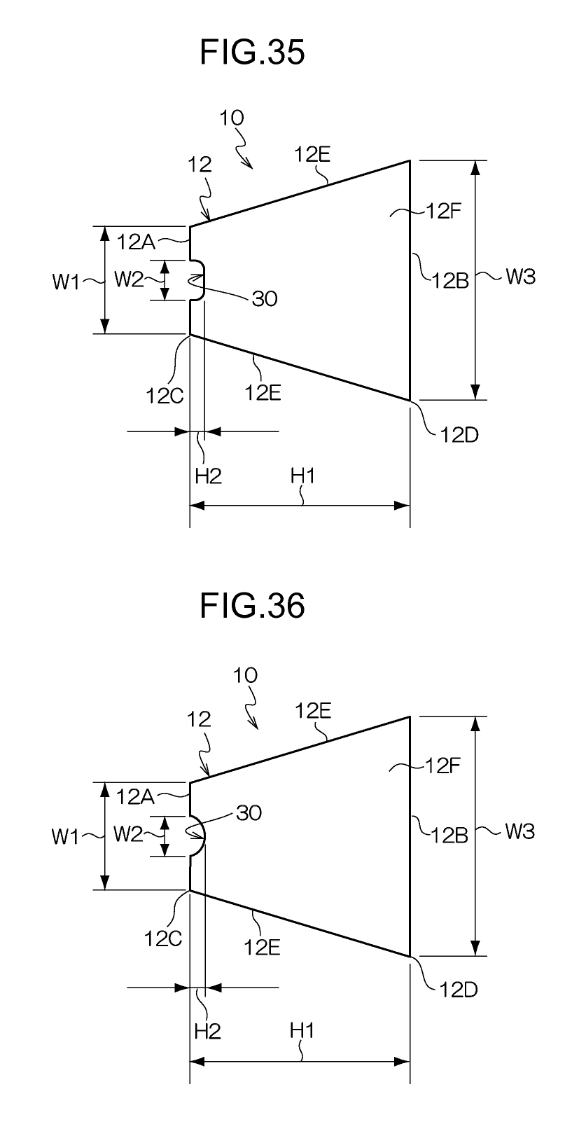

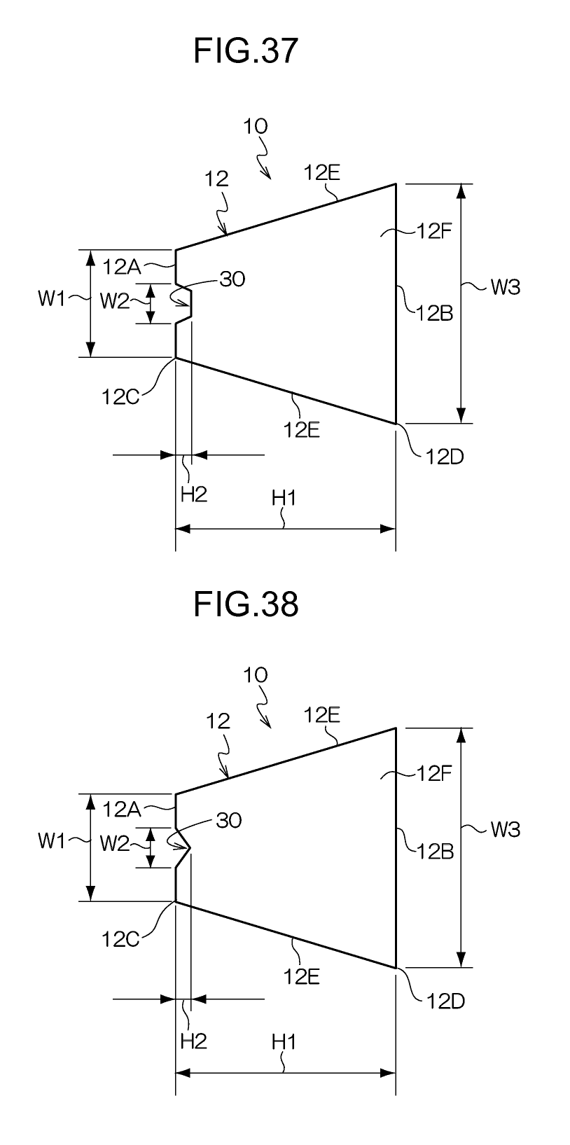

As in a fifteenth exemplary embodiment shown in FIG. 24 and FIG. 25 and in fifteenth to twenty-eighth embodiments shown in FIG. 26 to FIG. 38, a structure may be formed in which the slot 30 is formed from the upper end to the lower end of the impact surface 12A and divides the impact surface 12A in two between left and right.

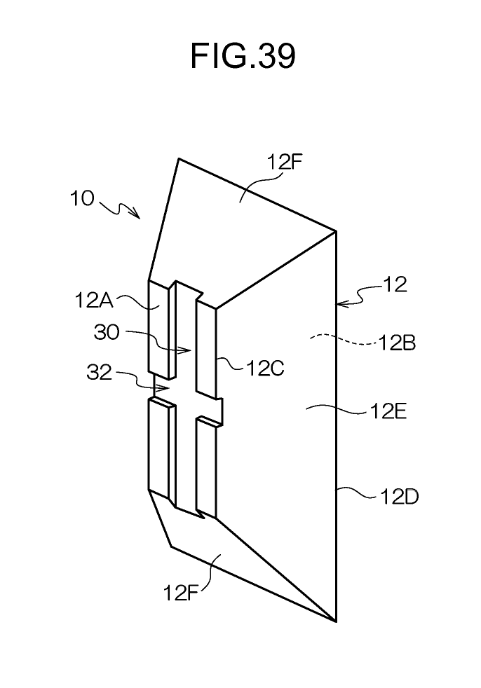

As in a twenty-ninth exemplary embodiment shown in FIG. 39, a slot 32 that crosses the slot 30 may be formed in the impact surface 12A of the main body portion 12 of the impact absorber 10.

Further still, although it is preferable to use the impact absorber 10 of the present invention for the knee area, disposing the impact absorber 10 at the inner side of the instrument panel 16 (the opposite side of the instrument panel 16 from the vehicle cabin interior side thereof) and protecting the knee area M1 of the occupant M, the present invention is also applicable to other impact absorbers that are disposed at the inner side of doors, pillars, the roof and the like of the automobile body 14 and protect occupants.

The shape of the main body portion 12 of the impact absorber 10 may be another shape in accordance with a location of mounting in the automobile body 14.

1. An impact absorber comprising:
a main body portion structured as a three-dimensional body formed of stiff polyurethane foam; and
a slot formed in an impact surface of the main body portion, which impact surface receives an impact,
wherein a ratio (W2/W1) of a width W2 of the slot to a width W1 of the impact surface is in a range from ⅙ to ½.

2. The impact absorber according to claim 1, wherein the impact surface has an elongated shape, and the slot is formed along the length direction of the impact surface.

3. The impact absorber according to claim 1, wherein the slot is formed at a central portion of the impact surface.

4. The impact absorber according to claim 1, wherein the impact surface of the main body portion is smaller than a base surface at the opposite side of the main body portion from the side thereof at which the impact surface is provided, and, viewed from the impact surface side, an outline of the impact surface is within an outline of the base surface.

5. The impact absorber according to claim 1, wherein a ratio (H2/H1) of a depth H2 of the slot to a height H1 of the impact surface from a base surface of the main body portion is in a range from 0.05 to 0.15.

6. The impact absorber according to claim 1, wherein the main body portion is disposed at a region opposing a knee area of an occupant sitting on a seat, and the slot is formed along an up-and-down direction.
